(19) United States
(12) Patent Application Publication
(10) Pub. No.: US 2010/0128071 A1
(43) Pub. Date: May 27, 2010

(54) SYSTEM AND METHOD FOR FULLY-AUTOMATICALLY ALIGNING QUALITY OF IMAGE

(75) Inventor: Shih-Hua Tseng, Taipei (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: Tatung Company, Taipei (TW)

(21) Appl. No.: 12/352,580

(22) Filed: Jan. 12, 2009

(30) Foreign Application Priority Data
Nov. 25, 2008 (TW) 97145546

(51) Int. Cl. G09G 5/00

(52) U.S. Cl. 345/698; 345/213

(57) ABSTRACT

A system and a method for fully-automatically aligning the quality of image are provided. The system and the method process the video signal provided by the Video Graphic Array (VGA) display card of the computer host through the multi-sync display itself, so as to achieve the purpose of fully-automatically aligning the quality of the image displayed on the multi-sync display. Therefore, even if the multi-sync display is situated under changing the computer hosts with different Video Graphics Array (VGA) display card or where place may be untouchable by users, the trouble caused by pressing a button on the multi-sync display to align the quality of the image displayed on the multi-sync display in conventional can be prevented.

### CROSS-REFERENCE TO RELATED APPLICATION

This application claims the priority benefit of Taiwan application serial no. 97145546, filed on Nov. 25, 2008. The entirety of the above-mentioned patent application is hereby incorporated by reference herein and made a part of specification.

### BACKGROUND OF THE INVENTION

1. Field of the Invention

The present invention relates to an alignment technology for images of the multi-sync display, more particularly, to a system and a method for fully-automatically aligning the quality of images displayed by the multi-sync display.

2. Description of the Related Art

In general, the requirement of the quality of images displayed by the computer display (also could be called “the multi-sync display”) is highest than the television, and further the manufacturers fabricating the video graphic array (VGA) display card are miscellaneous. Accordingly, the same multi-sync display is situated under changing the computer hosts with different VGA display card, the images displayed by the multi-sync display would be produced the problems of the color shift and/or the deviations of the size and position. For solving such problems, a button is fabricated on the multi-sync display in conventional to call an on-screen-display (OSD) menu for providing to users selecting, and the images displayed by the multi-sync display would be aligned by changing the image signal and the horizontal and vertical synchronization signal provided by the VGA display card of the computer host. Therefore, the multi-sync display would display the optimal images to users watching.

From the above, in order to overcome the problems of the color shift and/or the deviations of the size and position of the images displayed by the multi-sync display in conventional, it should be relied on users pressing the button to collocate with the alignment mechanism of the computer host. However, when the place of the multi-sync display is untouchable by users, the conventional solution for solving the problems of the color shift and/or the deviations of the size and position of the images displayed by the multi-sync display is inconvenient and insufficient.

### SUMMARY OF THE INVENTION

The present invention is directed to a system and a method for fully-automatically aligning the quality of images. The system and the method could prevent the trouble caused by pressing the button on the multi-sync display to align the quality of the image displayed on the multi-sync display when the multi-sync display is situated under changing the computer hosts with different VGA display card or where place may be untouchable by users.

The present invention provides a system for fully-automatically aligning the quality of images. The system includes a computer host and a multi-sync display. The computer host includes a video graphic array (VGA) display card which is used for at least providing an image signal, a horizontal and vertical synchronization (H/V SYNC) signal, and a detecting start signal. The multi-sync display includes a panel display module, a first memory, a detection unit and a processing chip. The panel display module is used for displaying an image.

The first memory is used for storing a preset color level alignment value, a plurality of preset timing flags, a plurality of preset timing parameters respectively corresponding to the preset timing flags, and a plurality of preset timing alignment values respectively- corresponding to the preset timing parameters, and reserving a memory space to expand a plurality of self-set timing flags, a plurality of self-set timing parameters respectively corresponding to the self-set timing flags, and a plurality of self-set timing alignment values respectively corresponding to the self-set timing parameters, so as to form a first timing data table.

The detection unit is used for detecting whether the multi-sync display under the power on is connected with the VGA display card of the computer host under the power on through a display cable, and providing a detecting trigger signal according to the detecting start signal. The processing chip is coupled to the panel display module, the first memory and the detection unit, for receiving and determining whether the detecting trigger signal is asserted from a first state to a second state.

When the processing chip determines that the detecting trigger signal is asserted from the first state to the second state, the processing chip receives the image signal and the H/V SYNC signal provided by the VGA display card of the computer host through the display cable, and performs a color level automatic alignment and a timing automatic alignment to the image signal and/or the H/V SYNC signal, so as to configure the state of the preset timing flags and the self-set timing flags, and obtain a color level automatic alignment value and a timing automatic alignment value to align the quality of the image displayed by the panel display module.

The present invention also provides a method for fully-automatically aligning the quality of images. The method includes the following steps of: firstly, disposing a first memory and a second memory in a multi-sync display. The first memory is used for storing a preset color level alignment value, a plurality of preset timing flags, a plurality of preset timing parameters respectively corresponding to the preset timing flags, and a plurality of preset timing alignment values respectively corresponding to the preset timing parameters, and reserving a memory space to expand a plurality of self-set timing flags, a plurality of self-set timing parameters respectively corresponding to the self-set timing flags, and a plurality of self-set timing alignment values respectively corresponding to the self-set timing parameters, so as to form a first timing data table.

The second memory is used for temporarily storing a reference timing parameter, a current timing parameter and a current timing alignment value, so as to form a second timing data table, the reference timing parameter is a previous timing parameter or an invalid timing parameter.

Next, detecting whether the multi-sync display under the power on is connected with a video graphic array (VGA) display card of a computer host under the power on through a display cable, and providing a detecting trigger signal accordingly. Finally, when the detecting trigger signal is asserted from the first state to the second state, performing a color level automatic alignment and a timing automatic alignment to an image signal and/or a horizontal and vertical synchronization (H/V SYNC) signal provided by the VGA display card of the computer host, so as to configure the state of the preset timing flags and the self-set timing flags, and obtain a color level automatic alignment value and a timing automatic alignment value to align the quality of an image displayed by a panel display module of the multi-sync display.

The system and the method provided by the present invention process the video signal provided by the VGA display card of the computer host through the multi-sync display itself, so as to achieve the purpose of fully-automatically aligning the quality of the image displayed on the multi-sync display. Therefore, even if the multi-sync display is situated under changing the computer hosts with different VGA display card or where place may be untouchable by users, the trouble caused by pressing a button on the multi-sync display to align the quality of the image displayed on the multi-sync display in conventional can be prevented.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a block diagram of a system for fully-automatically aligning the quality of images according to an exemplary embodiment of the present invention.

FIG. 2A is a memory configuration diagram of an EEPROM timing data table according to an exemplary embodiment of the present invention.

FIG. 2B is a memory configuration diagram of a RAM timing data table according to an exemplary embodiment of the present invention.

FIG. 3 is flow chart of a method for fully-automatically aligning the quality of images according to an exemplary embodiment of the present invention.

### DESCRIPTION OF THE PREFERRED EMBODIMENTS

Reference will now be made in detail to the present preferred embodiments of the invention, examples of which are illustrated in the accompanying drawings.

The present invention is directed to a system and a method for fully-automatically aligning the quality of images displayed by the multi-sync display. Below, the characteristics and advantages of the technique in the present invention will be described in detail.

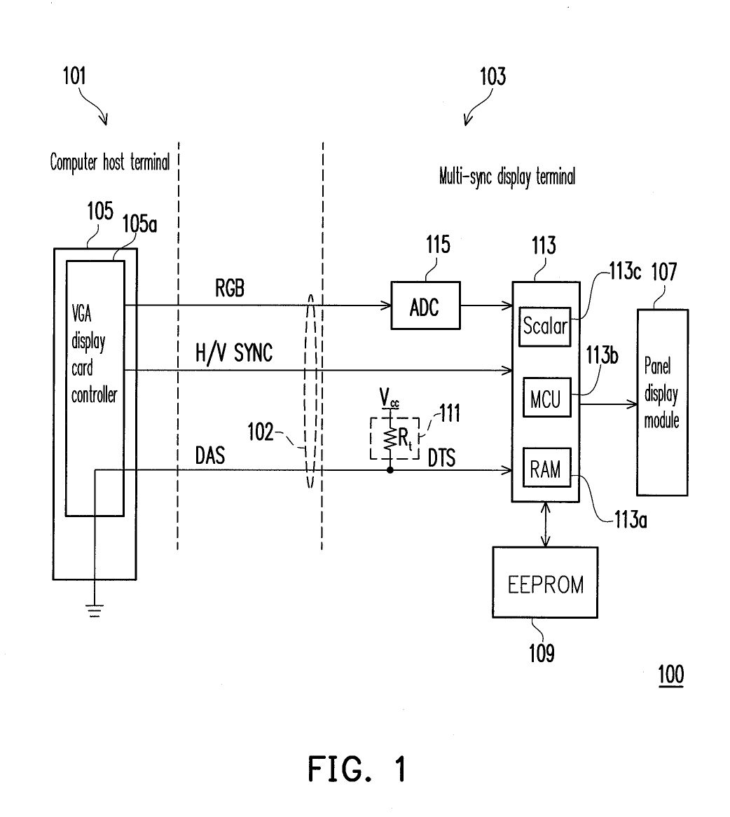

FIG. 1 is a block diagram of a system for fully-automatically aligning the quality of images according to an exemplary embodiment of the present invention. Referring to FIG. 1, the system 100 includes a computer host 101 and a multi-sync display 103, wherein the computer host 101 has a video graphic array (VGA) display card 105 for providing an image signal RGB, a horizontal and vertical synchronization signal H/V SYNC and a detecting start signal DAS through a VGA display card controller 105a therein. Of course, the computer host 101 may further include other components (not shown in FIG. 1) such as CPU, network card, I/O interface, . . . etc., but FIG. 1 merely shows the relative components to explain the exemplary embodiment.

The multi-sync display 103 includes a panel display module 107, a memory 109 (for example, an EEPROM, but not limited thereto, other non-volatile memories could be replaced the memory 109), a detection unit 111 and a processing chip 113, for example, including an inner memory 113a, an inner microprocessor (MCU) 113b and an inner scalar chip 113c. In general, the multi-sync display 103 connects with the VGA display card 105 through a display cable (for example, VGA cable). The panel display module 107 is used for displaying an image.

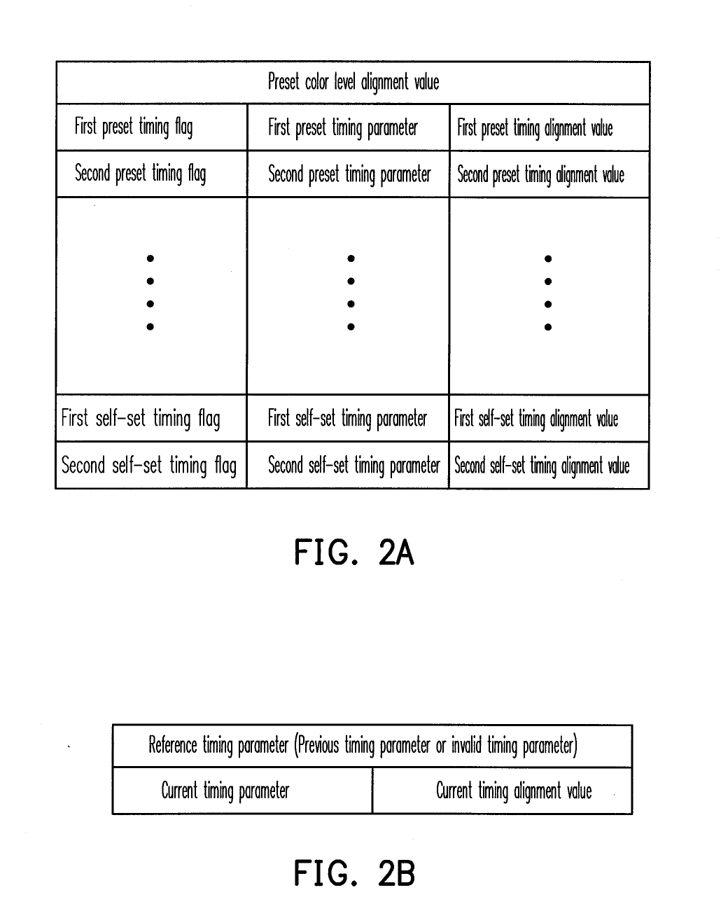

The memory 109 is used for storing a preset color level alignment value, a plurality of preset timing flags, a plurality of preset timing parameters respectively corresponding to the preset timing flags, and a plurality of preset timing alignment values respectively corresponding to the preset timing parameters, and reserving a memory space to expand a plurality of self-set timing flags, a plurality of self-set timing parameters respectively corresponding to the self-set timing flags, and a plurality of self-set timing alignment values respectively corresponding to the self-set timing parameters, so as to form an EEPROM timing data table. In the exemplary embodiment, the memory configuration relationship of the EEPROM timing data table stored in the memory 109 approximately shows as FIG. 2A.

The detection unit 111 is used for detecting whether the multi-sync display 103 under the power on is connected with the VGA display card 105 of the computer host 101 under the power on through the display cable 102, and providing a detecting trigger signal DTS to the processing chip 113 according to the detecting start signal DAS. In the exemplary embodiment, the detection unit 111 is composed of a resistor Rt. One terminal of the resistor Rt is coupled to a system voltage Vcc of the multi-sync display 103, and another terminal of the the resistor Rt is directly coupled to the processing chip 113 and coupled to a ground potential of the VGA display card 105 through the display cable 102.

It should be noted that since the processing chip 113 merely processes the digital signals, so that the analog image signal RGB provided by the VGA display card controller 105a should be firstly converted by the analog to digital converter (ADC) 115, and then the converted image signal RGB would be provided to the processing chip 113 for performing follow-up signal processing. However, such conversion technique is generally known by one person having ordinary skilled in the art, accordingly, it would be omitted herein.

The processing chip 113 is coupled to the panel display module 107, the memory 109 and the detection unit 111. The processing chip 113 includes the inner memory 113a (for example, a RAM, but not limited thereto, other volatile memories could be replaced the memory 113a). The memory 113a is used for temporarily storing a reference timing parameter, a current timing parameter and a current timing alignment value, so as to form a RAM timing data table, wherein the reference timing parameter is a previous timing parameter or an invalid timing parameter. In the exemplary embodiment, the memory configuration relationship of the RAM timing data table stored in the memory 113a approximately shows as FIG. 2B.

The processing chip 113 is used for receiving and determining whether the detecting trigger signal DTS is asserted from a logic high state to a logic low state. In the exemplary embodiment, when the processing chip 113 determines that the detecting trigger signal DTS is asserted from the logic high state to the logic low state, the processing chip 113 receives the image signal RGB and the horizontal and vertical synchronization signal H/V SYNC (i.e. valid timing signal) provided by the VGA display card controller 105a through the display cable 102, and performs a color level automatic alignment and a timing automatic alignment to the image signal RGB and/or the horizontal and vertical synchronization signal H/V SYNC, so as to configure all of the state of the preset timing flags and the self-set timing flags, and obtain a color level automatic alignment value and a timing automatic alignment value to align the quality of the image displayed by the panel display module 107.

To be specific, once the multi-sync display 103 under power on connects with the computer host 101 under power on through the display cable 102, the processing chip would immediately determine that the detecting trigger signal DTS is asserted from the logic high state to the logic low state. Accordingly, the processing chip 113 would activate the mechanism for fully-automatically aligning the quality of the image displayed by the panel display module 107.

In the exemplary embodiment, when the processing chip 113 determines that the detecting trigger signal DTS is asserted from the logic high state to the logic low state (when the multi-sync display 103 and the computer host 101 both are situated in power on and merely connected with each other at the first time), the processing chip 113 would firstly set all of the preset timing flags and the self-set timing flags to “1”, and then perform the color level automatic alignment to the digital image signal RGB so as to obtain the color level automatic alignment value to replace the preset color level alignment value of the EEPROM timing data table, and after that, the processing chip 113 would output the color level automatic alignment value to the panel display module 107.

Accordingly, when the processing chip 113 outputs the color level automatic alignment value to the panel display module 107, or determines that the detecting trigger signal DTS is kept at the logic low state, the processing chip 113 would perform signal processing to the image signal RGB and the horizontal and vertical synchronization signal H/V SYNC provided by the VGA display card controller 105a, so as to obtain the current timing parameter and store the current timing parameter into the memory 113a. Thereafter, the processing chip 113 would compare whether the current timing parameter with the reference timing parameter is the same or not, so as to determine whether the horizontal and vertical synchronization signal H/V SYNC provided by the VGA display card controller 105a is changed or not.

In the exemplary embodiment, when the processing chip 113 compares that the current timing parameter in the RAM timing data table is not the same with the reference timing parameter in the RAM timing data table, the processing chip 113 determines that the horizontal and vertical synchronization signal H/V SYNC provided by the VGA display card controller 105a is changed. Herein, since the multi-sync display 103 connects with the computer host 101 through the display cable 102 at the first time, so that the reference timing parameter in the RAM timing data table is an invalid timing parameter. Accordingly, the processing chip 113 would compare that the current timing parameter is not the same with the reference timing parameter (i.e. the invalid timing parameter), so as to determine that the horizontal and vertical synchronization signal H/V SYNC provided by the VGA display card controller 105a is changed.

When the processing chip 113 determines that the horizontal and vertical synchronization signal H/V SYNC provided by the VGA display card controller 105a is changed, the processing chip 113 would search whether or not any one from the preset timing parameters and the self-set timing parameters in the memory 109 (i.e. the EEPROM timing data table) matches the current timing parameter. If there is one preset/self-set timing parameter matching the current timing parameter, the processing chip 113 would further determine whether or not the preset timing flag or the self-set timing flag of the matching one preset/self-set timing parameter is cleared to “0”.

In the exemplary embodiment, when the processing chip 113 determines that the preset timing flag or the self-set timing flag of the matching one preset/self-set timing parameter is cleared to “0”, the processing chip 113 would regard the preset timing alignment value or the self-set timing alignment value corresponding to the matching one preset/self-set timing parameter as the current timing alignment value, and store the current timing alignment value into the memory 113a, so as to obtain the timing automatic alignment value for outputting to the panel display module 107, and after that, the processing chip 113 would further replace the previous timing parameter or the invalid timing parameter with the current timing parameter, so as to regard the current timing parameter as the reference timing parameter.

However, when the processing chip 113 determines that the preset timing flag or the self-set timing flag of the matching one preset/self-set timing parameter is not cleared to “0”, the processing chip 113 would perform the timing automatic alignment to the image signal RGB and the horizontal and vertical synchronization signal H/V SYNC provided by the VGA display card controller 105a according to the current timing parameter, so as to obtain the timing automatic alignment value. Next, the processing chip 113 would replace the preset timing alignment value or the self-set timing alignment corresponding to the matching one preset/self-set timing parameter with the timing automatic alignment value. Thereafter, the processing chip 113 would clear the preset timing flag or the self-set flag of the matching one preset/self-set timing parameter to “0”, and after that, the processing chip 113 would further output the timing automatic alignment value to the panel display module 107, and replace the previous timing parameter or the invalid timing parameter with the current timing parameter, so as to regard the current timing parameter as the reference timing parameter.

In an another aspect, if there is no preset/self-set timing parameter matching the current timing parameter, the processing chip 113 would newly add an extra self-set timing flag into the reserved memory space of the memory 109, and duplicate an extra self-set timing parameter corresponding to the extra self-set timing flag according to the current timing parameter for newly adding the extra self-set timing parameter into the memory 109.

Next, the processing chip 113 would perform the timing automatic alignment to the image signal RGB and the horizontal and vertical synchronization signal H/V SYNC provided by the VGA display card controller 105a according to the current timing parameter, so as to obtain an extra self-set timing alignment value corresponding to current timing parameter, and newly add the extra self-set timing alignment value into the memory 109. Thereafter, the processing chip 113 would set the extra self-set timing flag to “0”, and regard the extra self-set timing alignment value as the current timing alignment value to store the extra self-set timing alignment value into the memory 113a, so as to obtain the timing automatic alignment value for outputting to the panel display module 107. Finally, the processing chip 113 would replace the previous timing parameter and the invalid timing parameter with the current timing parameter, so as to regard the current timing parameter as the reference timing parameter temporarily stored in the memory 113a (i.e. the RAM timing data table).

In the exemplary embodiment, when the processing chip 113 determines that the current timing parameter is the same with the reference timing parameter (at this time, the reference timing parameter has a previous timing parameter), the processing chip 113 determines that the horizontal and vertical synchronization signal H/V SYNC provided by the VGA display card controller 105a is not changed. Accordingly, the processing chip 113 does not align to the quality of the image displayed by the panel display module 107. Furthermore, if the horizontal and vertical synchronization signal H/V SYNC provided by the VGA display card controller 105a of the computer host 101 is an invalid timing signal, the processing chip 113 also does not align to the quality of the image displayed by the panel display module 107.

From the above, if only the reference timing parameter and the current timing parameter (both temporarily stored in the RAM timing data table of the memory 113a) is not the same, the processing chip 113 would perform the timing automatic alignment to the image signal RGB and the horizontal and vertical synchronization signal H/V SYNC provided by the VGA display card controller 105a, so as to obtain the timing automatic alignment value.

To be specific, when the processing chip 113 aligns the quality of the image displayed by the panel display module 107 at the first time, the processing chip 113 would obtain the current timing parameter to store in the RAM timing data table by calculating the current valid timing signal received by the processing chip 113. However, if the timing signal received by the processing chip 113 is an invalid timing signal, then the current timing parameter stored in the RAM timing data table is an invalid timing parameter. On the contrary, if the timing signal received by the processing chip 113 is a valid timing signal, then the ultimate current timing parameter stored in the RAM timing data table would replace the reference timing parameter, so as to make that the ultimate current timing parameter and the reference timing parameter are kept at the same. Accordingly, the processing chip 113 would be determined whether or not the horizontal and vertical synchronization signal H/V SYNC provided by the VGA display card controller 105a is changed.

In addition, it should be further noted that even though the mechanism for fully-automatically aligning the quality of the image displayed by the panel display module 107 is activated when the detecting trigger signal DTS is asserted from the logic high state to the logic low state in the above exemplary embodiment. However, in the other exemplary embodiments of the present invention, the mechanism for fully-automatically aligning the quality of the image displayed by the panel display module 107 is also activated when the detecting trigger signal DTS is asserted from the logic low state to the logic high state. It can be determined/defined by practical design requirement.

According to the above contents of the exemplary embodiment, below, a method for fully-automatically aligning the quality of images is summarized for one person having ordinary skilled in the art to refer.

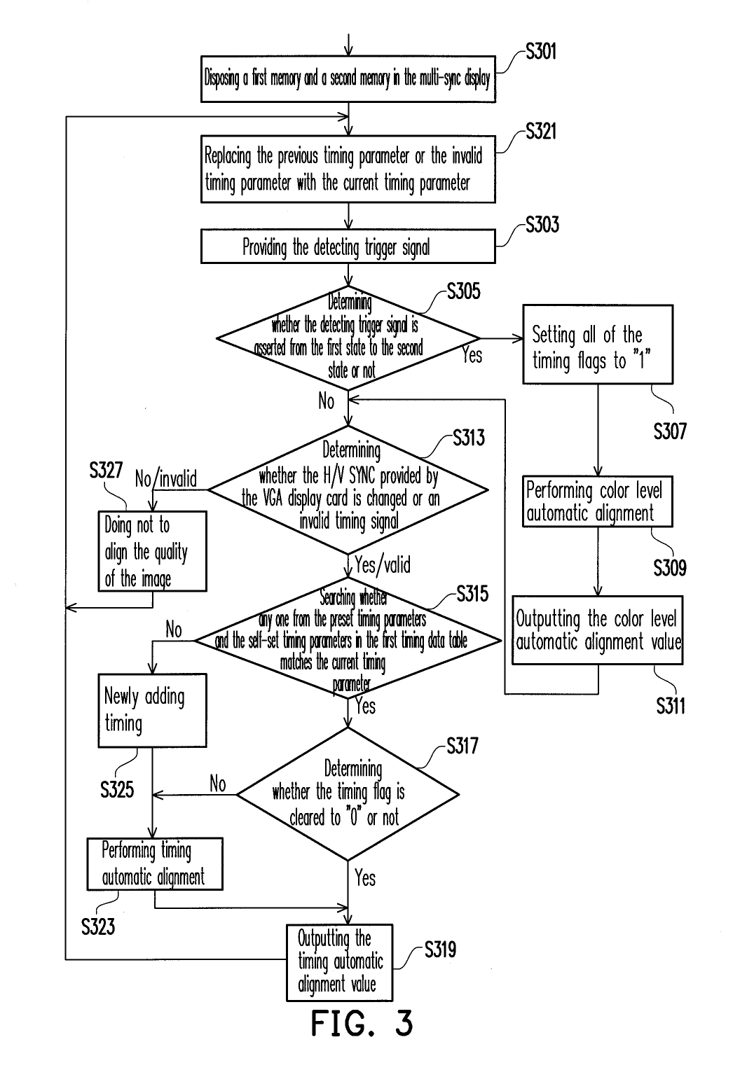

FIG. 3 is flow chart of a method for fully-automatically aligning the quality of images according to an exemplary embodiment of the present invention. Referring to FIG. 3, the method of the exemplary embodiment is suitable for executing by a processing chip of a multi-sync display, and the method includes the following steps of, in step S301, disposing a first memory and a second memory in the multi-sync display.

In the exemplary embodiment, the first memory (for example, an EEPROM, but not limited thereto, other non-volatile memories could be replaced the memory 109) is used for storing a preset color level alignment value, a plurality of preset timing flags, a plurality of preset timing parameters respectively corresponding to the preset timing flags, and a plurality of preset timing alignment values respectively corresponding to the preset timing parameters, and reserving a memory space to expand a plurality of self-set timing flags, a plurality of self-set timing parameters respectively corresponding to the self-set timing flags, and a plurality of self-set timing alignment values respectively corresponding to the self-set timing parameters, so as to form an EEPROM timing data table.

In addition, the second memory (for example, a RAM, but not limited thereto, other volatile memories could be replaced the memory 113a) is used for temporarily storing a reference timing parameter, a current timing parameter and a current timing alignment value, so as to form a RAM timing data table, wherein the reference timing parameter is a previous timing parameter or an invalid timing parameter, and the reference timing parameter is determined by the Step S321. Furthermore, the processing chip executing the method of the exemplary embodiment includes an inner microprocessor (MCU), an inner scalar and the second memory.

Next, in step S303, detecting whether the multi-sync display under the power on is connected with a video graphic array (VGA) display card of a computer host under the power on through a display cable, and providing a detecting trigger signal accordingly. In the exemplary embodiment, the step S03 includes disposing a resistor in the multi-sync display; coupling one terminal of the resistor to a system voltage of the multi-sync display; directly coupling another terminal of the resistor to a processing chip of the multi-sync display and coupling to a ground potential of the VGA display card of the computer host through the display cable.

Accordingly, when the multi-sync display under the power on is connected with the VGA display card of the computer host under the power on through the display cable, providing the detecting trigger signal, which is asserted from the first state to the second state or kept at the second state, to the processing chip.

Thereafter, in step S305, determining whether the detecting start signal is asserted from a first state (for example, a logic high state) to a second state (for example, a logic low state) or not. When the detecting trigger signal is asserted from the first state to the second state, the step S307 is performed, namely, setting all of the preset timing flags and the self-set timing flags to “1”. Next, in step S309, performing the color level automatic alignment to the image signal, so as to obtain the color level automatic alignment value to replace the preset color level alignment value. Next, in step S311, outputting the color level automatic alignment value to a panel display module of the multi-sync display.

In the exemplary embodiment, when the color level automatic alignment value is outputted to the panel display module or the detecting trigger signal is kept at the second state, the step S313 is performed, namely, performing signal processing to an image signal and a horizontal and vertical synchronization (hereafter, H/V SYNC) signal provided by the VGA display card of the computer host, so as to obtain the current timing parameter and store the current timing parameter into the RAM timing data table of the second memory; and thereafter, comparing whether the current timing parameter with the reference timing parameter is the same, so as to determine whether the H/V SYNC signal provided by the VGA display card of the computer host is changed.

If the current timing parameter is not the same with the reference timing parameter, then the H/V SYNC signal provided by the VGA display card of the computer host is changed. Accordingly, the step S315 is preformed, namely, searching whether any one from the preset timing parameters and the self-set timing parameters in the first timing data table matches the current timing parameter. If there is one preset/self-set timing parameter matching the current timing parameter, the step S317 is performed, namely, determining whether or not the preset timing flag or the self-set timing flag of the matching one preset/self-set timing parameter is cleared to “0”.

In the exemplary embodiment, when the preset timing flag or the self-set timing flag of the matching one preset/self-set timing parameter is cleared to “0”, the step S319 is performed, namely, regarding the preset timing alignment value or the self-set timing alignment value corresponding to the matching one preset/self-set timing parameter as the current timing alignment value, and storing the current timing alignment value into the RAM timing data table of the second memory, so as to obtain the timing automatic alignment value for outputting to the panel display module; and thereafter, replacing the previous timing parameter or the invalid timing parameter with the current timing parameter, so as to regard the current timing parameter as the reference timing parameter.

In an another aspect, when the preset timing flag or the self-set timing flag of the matching one preset/self-set timing parameter is not cleared to “0”, the step S323 is performed, namely, performing the timing automatic alignment to the image signal and the H/V SYNC signal provided by the VGA display card of the computer host according to the current timing parameter, so as to obtain the timing automatic alignment value; next, replacing the preset timing alignment value or the self-set timing alignment corresponding to the matching one preset/self-set timing parameter with the timing automatic alignment value; and next, clearing the preset timing flag or the self-set flag of the matching one preset/self-set timing parameter to “0”.

Thereafter, in step S319, outputting the timing automatic alignment value to the panel display module, and next, in step S321, replacing the previous timing parameter or the invalid timing parameter with the current timing parameter, so as to regard the current timing parameter as the reference timing parameter.

However, if there is no preset/self-set timing parameter matching the current timing parameter determined by the step S315, the step S325 is performed, namely, newly adding an extra self-set timing flag into the memory space of the first memory; and duplicating an extra self-set timing parameter corresponding to the extra self-set timing flag according to the current timing parameter, and newly adding the extra self-set timing parameter into the EEPROM timing data table in the first memory.

Next, in step S323, performing the timing automatic alignment to the image signal and the H/V SYNC signal provided by the VGA display card of the computer host according to the current timing parameter, so as to obtain an extra self-set timing alignment value corresponding to current timing parameter, and newly adding the extra self-set timing alignment value into the RAM timing data table of the first memory; and next, setting the extra self-set timing flag to “0”. Thereafter, in step S319, regarding the extra self-set timing alignment value as the current timing alignment value, and storing the extra self-set timing alignment value into the second memory so as to obtain the timing automatic alignment value for outputting to the panel display module; and next the step S321 is performed, namely, replacing the previous timing parameter and the invalid timing parameter with the current timing parameter, so as to regard the current timing parameter as the reference timing parameter temporarily stored in the RAM timing data table of the second memory.

In the exemplary embodiment, if the current timing parameter is the same with the reference timing parameter determined by the step S313, then the H/V SYNC signal provided by the VGA display card of the computer host is not changed. Accordingly, the step S327 is performed, namely, doing not align to the quality of the image displayed by the panel display module.

Furthermore, if the H/V SYNC signal provided by the VGA display card of the computer host is an invalid timing signal, the step S327 is also performed, namely, doing not align to the quality of the image displayed by the panel display module.

In addition, before performing the step of performing the color level automatic alignment and the timing automatic alignment to the image signal and/or the H/V SYNC signal provided by the VGA display card of the computer host in the exemplary embodiment, the method of the exemplary embodiment would convert the image signal from the analog to the digital. However, such conversion technique is generally known by one person having ordinary skilled in the art, accordingly, it would be omitted herein.

In summary, the system and the method provided by the present invention process the video signal provided by the VGA display card of the computer host through the multi-sync display itself, so as to achieve the purpose of fully-automatically aligning the quality of the image displayed on the multi-sync display. Therefore, even if the multi-sync display is situated under changing the computer hosts with different VGA display card or where place may be untouchable by users, the trouble caused by pressing a button on the multi-sync display to align the quality of the image displayed on the multi-sync display in conventional can be prevented.

It will be apparent to those skills in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A system for fully-automatically aligning the quality of images, the system comprising:
a computer host, comprising a video graphic array (VGA) display card which is used for at least providing an image signal, a horizontal and vertical synchronization (H/V SYNC) signal, and a detecting start signal; and
a multi-sync display, comprising:
a panel display module, for displaying an image;
a first memory, for storing a preset color level alignment value, a plurality of preset timing flags, a plurality of preset timing parameters respectively corresponding to the preset timing flags, and a plurality of preset timing alignment values respectively corresponding to the preset timing parameters, and reserving a memory space to expand a plurality of self-set timing flags, a plurality of self-set timing parameters respectively corresponding to the self-set timing flags, and a plurality of self-set timing alignment values respectively corresponding to the self-set timing parameters, so as to form a first timing data table;
a detection unit, for detecting whether the multi-sync display under the power on is connected with the VGA display card of the computer host under the power on through a display cable, and providing a detecting trigger signal according to the detecting start signal; and
a processing chip, coupled to the panel display module, the first memory and the detection unit, for receiving and determining whether the detecting trigger signal is asserted from a first state to a second state, wherein when the processing chip determines that the detecting trigger signal is asserted from the first state to the second state, the processing chip receives the image signal and the H/V SYNC signal provided by the VGA display card of the computer host through the display cable, and performs a color level automatic alignment and a timing automatic alignment to the image signal and/or the H/V SYNC signal, so as to configure the state of the preset timing flags and the self-set timing flags, and obtain a color level automatic alignment value and a timing automatic alignment value to align the quality of the image displayed by the panel display module.

2. The system according to claim 1, wherein when the processing chip determines that the detecting trigger signal is asserted from the first state to the second state, the processing chip is configured to:
set all of the preset timing flags and the self-set timing flags to “1”;
perform the color level automatic alignment to the image signal, so as to obtain the color level automatic alignment value to replace the preset color level alignment value; and
output the color level automatic alignment value to the panel display module.

3. The system according to claim 2, wherein the processing chip comprises an inner second memory, for temporarily storing a reference timing parameter, a current timing parameter and a current timing alignment value, so as to form a second timing data table, wherein the reference timing parameter is a previous timing parameter or an invalid timing parameter.

4. The system according to claim 3, wherein when the processing chip outputs the color level automatic alignment value to the panel display module, or determines that the detecting trigger signal is kept at the second state, the processing chip is further configure to:
perform signal processing to the image signal and the H/V SYNC signal provided by the VGA display card of the computer host, so as to obtain the current timing parameter and store the current timing parameter into the second memory; and
compare whether the current timing parameter with the reference timing parameter is the same, so as to determine whether the H/V SYNC signal provided by the VGA display card of the computer host is changed.

5. The system according to claim 4, wherein when processing chip compares that the current timing parameter is not the same with the reference timing parameter, the processing chip determines that the H/V SYNC signal provided by the VGA display card of the computer host is changed.

6. The system according to claim 5, wherein when the processing chip determines that the H/V SYNC signal provided by the VGA display card of the computer host is changed, the processing chip is further configured to:
search whether any one from the preset timing parameters and the self-set timing parameters in the first memory matches the current timing parameter.

7. The system according to claim 6, wherein if there is one preset/self-set timing parameter matching the current timing parameter, the processing chip is further configured to:
determine whether the preset timing flag or the self-set timing flag of the matching one preset/self-set timing parameter is cleared to “0”.

8. The system according to claim 7, wherein when the processing chip determines that the preset timing flag or the self-set timing flag of the matching one preset/self-set timing parameter is cleared to “0”, the processing chip is further configured to:
regard the preset timing alignment value or the self-set timing alignment value corresponding to the matching one preset/self-set timing parameter as the current timing alignment value, and store the current timing alignment value into the second memory, so as to obtain the timing automatic alignment value for outputting to the panel display module; and
replace the previous timing parameter or the invalid timing parameter with the current timing parameter, so as to regard the current timing parameter as the reference timing parameter.

9. The system according to claim 7, wherein when the processing chip determines that the preset timing flag or the self-set timing flag of the matching one preset/self-set timing parameter is not cleared to “0”, the processing chip is further configured to:
perform the timing automatic alignment to the image signal and the H/V SYNC signal provided by the VGA display card of the computer host according to the current timing parameter, so as to obtain the timing automatic alignment value;
replace the preset timing alignment value or the self-set timing alignment corresponding to the matching one preset/self-set timing parameter with the timing automatic alignment value;
clear the preset timing flag or the self-set flag of the matching one preset/self-set timing parameter to “0”; and
output the timing automatic alignment value to the panel display module, and replace the previous timing parameter or the invalid timing parameter with the current timing parameter, so as to regard the current timing parameter as the reference timing parameter.

10. The system according to claim 6, wherein if there is no preset/self-set timing parameter matching the current timing parameter, the processing chip is further configured to:
newly add an extra self-set timing flag into the memory space of the first memory;
duplicate an extra self-set timing parameter corresponding to the extra self-set timing flag according to the current timing parameter, and newly add the extra self-set timing parameter into the memory space of the first memory;
perform the timing automatic alignment to the image signal and the H/V SYNC signal provided by the VGA display card of the computer host according to the current timing parameter, so as to obtain an extra self-set timing alignment value corresponding to current timing parameter, and newly add the extra self-set timing alignment value into the memory space of the first memory;
set the extra self-set timing flag to “0”;
regard the extra self-set timing alignment value as the current timing alignment value, and store the extra self-set timing alignment value into the second memory so as to obtain the timing automatic alignment value for outputting to the panel display module; and
replace the previous timing parameter and the invalid timing parameter with the current timing parameter, so as to regard the current timing parameter as the reference timing parameter temporarily stored in the second memory.

11. The system according to claim 4, wherein when the processing chip determines that the current timing parameter is the same with the reference timing parameter, the processing chip determines that the H/V SYNC signal provided by the VGA display card of the computer host is not changed.

12. The system according to claim 11, wherein when the processing chip determines that the H/V SYNC signal provided by the VGA display card of the computer host is not changed or an invalid timing signal, the processing chip does not align to the quality of the image.

13. The system according to claim 3, wherein the first memory is a non-volatility memory and the second memory is a volatility memory.

14. The system according to claim 13, wherein the non-volatility memory at least comprises an electrically erasable programmable read only memory (EEPROM) and the volatility at least comprises a random access memory (RAM).

15. The system according to claim 1, wherein the detection unit comprises:
a resistor, having one terminal coupled to a system voltage of the multi-sync display, and another terminal directly coupled to the processing chip and coupled to a ground potential of the VGA display card of the computer host through the display cable.

16. The system according to claim 15, wherein the first state is a logic high state and the second state is a logic low state.

17. The system according to claim 1, wherein the multi-sync display further comprises:
an analog to digital converter (ADC), for receiving the image signal through the display cable, and converting the received image signal from the analog to the digital so as to provide the converted image signal to the processing chip for performing the color level automatic alignment and/or the timing automatic alignment.

18. The system according to claim 3, wherein the processing chip further comprises an inner microprocessor and a scalar chip.

19. A method for fully-automatically aligning the quality of images, the method comprising:
disposing a first memory and a second memory in a multi-sync display, wherein:
the first memory is used for storing a preset color level alignment value, a plurality of preset timing flags, a plurality of preset timing parameters respectively corresponding to the preset timing flags, and a plurality of preset timing alignment values respectively corresponding to the preset timing parameters, and reserving a memory space to expand a plurality of self-set timing flags, a plurality of self-set timing parameters respectively corresponding to the self-set timing flags, and a plurality of self-set timing alignment values respectively corresponding to the self-set timing parameters, so as to form a first timing data table; and
the second memory is used for temporarily storing a reference timing parameter, a current timing parameter and a current timing alignment value, so as to form a second timing data table, the reference timing parameter is a previous timing parameter or an invalid timing parameter;
detecting whether the multi-sync display under the power on is connected with a video graphic array (VGA) display card of a computer host under the power on through a display cable, and providing a detecting trigger signal accordingly; and
when the detecting trigger signal is asserted from the first state to the second state, performing a color level automatic alignment and a timing automatic alignment to an image signal and/or a horizontal and vertical synchronization (H/V SYNC) signal provided by the VGA display card of the computer host, so as to configure the state of the preset timing flags and the self-set timing flags, and obtain a color level automatic alignment value and a timing automatic alignment value to align the quality of an image displayed by a panel display module of the multi-sync display.

20. The method according to claim 19, wherein when the detecting trigger signal is asserted from the first state to the second state, the method performs the following steps of:
setting all of the preset timing flags and the self-set timing flags to “1”;
performing the color level automatic alignment to the image signal, so as to obtain the color level automatic alignment value to replace the preset color level alignment value; and
outputting the color level automatic alignment value to the panel display module.

21. The method according to claim 20, wherein when the color level automatic alignment value is outputted to the panel display module or the detecting trigger signal is kept at the second state, the method further performs the following steps of:
performing signal processing to the image signal and the H/V SYNC signal provided by the VGA display card of the computer host, so as to obtain the current timing parameter and store the current timing parameter into the second timing data table of the second memory; and
comparing whether the current timing parameter with the reference timing parameter is the same, so as to determine whether the H/V SYNC signal provided by the VGA display card of the computer host is changed.

22. The method according to claim 21, wherein if the current timing parameter is not the same with the reference timing parameter, then the H/V SYNC signal provided by the VGA display card of the computer host is changed.

23. The method according to claim 22, wherein when the H/V SYNC signal provided by the VGA display card of the computer host is changed, the method further performs the following step of:
searching whether any one from the preset timing parameters and the self-set timing parameters in the first timing data table matches the current timing parameter.

24. The method according to claim 23, wherein if there is one preset/self-set timing parameter matching the current timing parameter, the method further performs the following step of:
determining whether the preset timing flag or the self-set timing flag of the matching one preset/self-set timing parameter is cleared to “0”.

25. The method according to claim 24, wherein when the preset timing flag or the self-set timing flag of the matching one preset/self-set timing parameter is cleared to “0”, the method further performs the following steps of:
regarding the preset timing alignment value or the self-set timing alignment value corresponding to the matching one preset/self-set timing parameter as the current timing alignment value, and storing the current timing alignment value into the second timing data table of the second memory, so as to obtain the timing automatic alignment value for outputting to the panel display module; and
replacing the previous timing parameter or the invalid timing parameter with the current timing parameter, so as to regard the current timing parameter as the reference timing parameter.

26. The method according to claim 24, wherein when the preset timing flag or the self-set timing flag of the matching one preset/self-set timing parameter is not cleared to “0”, the method further performs the following steps of:
performing the timing automatic alignment to the image signal and the H/V SYNC signal provided by the VGA display card of the computer host according to the current timing parameter, so as to obtain the timing automatic alignment value;
replacing the preset timing alignment value or the self-set timing alignment corresponding to the matching one preset/self-set timing parameter with the timing automatic alignment value;
clearing the preset timing flag or the self-set flag of the matching one preset/self-set timing parameter to “0”; and
outputting the timing automatic alignment value to the panel display module, and replacing the previous timing parameter or the invalid timing parameter with the current timing parameter, so as to regard the current timing parameter as the reference timing parameter.

27. The method according to claim 23, wherein if there is no preset/self-set timing parameter matching the current timing parameter, the method further performs the following steps of:
newly adding an extra self-set timing flag into the memory space of the first memory;
duplicating an extra self-set timing parameter corresponding to the extra self-set timing flag according to the current timing parameter, and newly adding the extra self-set timing parameter into the memory space of the first memory;
performing the timing automatic alignment to the image signal and the H/V SYNC signal provided by the VGA display card of the computer host according to the current timing parameter, so as to obtain an extra self-set timing alignment value corresponding to current timing parameter, and newly adding the extra self-set timing alignment value into the memory space of the first memory;
setting the extra self-set timing flag to “0”;
regarding the extra self-set timing alignment value as the current timing alignment value, and storing the extra self-set timing alignment value into the second memory so as to obtain the timing automatic alignment value for outputting to the panel display module; and
replacing the previous timing parameter and the invalid timing parameter with the current timing parameter, so as to regard the current timing parameter as the reference timing parameter temporarily stored in the second timing data table of the second memory.

28. The method according to claim 21, wherein if the current timing parameter is the same with the reference timing parameter, then the H/V SYNC signal provided by the VGA display card of the computer host is not changed.

29. The method according to claim 28, wherein when the H/V SYNC signal provided by the VGA display card of the computer host is not changed or an invalid timing signal, the method further performs the following step of:
doing not align to the quality of the image.

30. The method according to claim 21, wherein the step of “detecting whether the multi-sync display under the power on is connected with the VGA display card of the computer host under the power on through the display cable, and providing the detecting trigger signal accordingly” comprises:
disposing a resistor in the multi-sync display;
coupling one terminal of the resistor to a system voltage of the multi-sync display;
directly coupling another terminal of the resistor to a processing chip of the multi-sync display and coupling to a ground potential of the VGA display card of the computer host through the display cable; and
when the multi-sync display under the power on is connected with the VGA display card of the computer host under the power on through the display cable, providing the detecting trigger signal, which is asserted from the first state to the second state or kept at the second state, to the processing chip.

31. The method according to claim 30, wherein the first state is a logic high state and the second state is a logic low state.

32. The method according to claim 30, wherein the processing chip comprises an inner microprocessor, an inner scalar and the second memory, and the processing chip is suitable for executing the method.

33. The method according to claim 19, wherein before the step of “performing the color level automatic alignment and the timing automatic alignment to the image signal and/or the H/V SYNC signal provided by the VGA display card of the computer host”, the method further performs the following step of:
converting the image signal from the analog to the digital.

34. The method according to claim 19, wherein the first memory is a non-volatility memory and the second memory is a volatility memory.

35. The method according to claim 34, wherein the non-volatility memory at least comprises an electrically erasable programmable read only memory (EEPROM) and the volatility at least comprises a random access memory (RAM).
